(19) United States
(12) Patent Application Publication
(10) Pub. No.: US 2024/0330851 A1
(43) Pub. Date: Oct. 3, 2024

(54) METHOD, INFORMATION PROCESSING APPARATUS, AND NON-TRANSITORY COMPUTER READABLE MEDIUM

(71) Applicant: TOYOTA JIDOSHA KABUSHIKI KAISHA, Aichi-ken (JP)

(72) Inventors: Hiroto TOMIDA, Tokyo-to (JP); Motohiro NAKAMURA, Okazaki-shi (JP); Jean-Sebastien BOIRE, Yokohama-shi (JP); Ryusaku YAMAMOTO, Tokyo-to (JP); Kohei WATANABE, Tokyo-to (JP)

(21) Appl. No.: 18/613,113

(22) Filed: Mar. 22, 2024

(30) Foreign Application Priority Data
Mar. 31, 2023 (JP) 2023-059352

(51) Int. Cl. G06Q 10/087; G06Q 10/083

(52) U.S. Cl. CPC G06Q 10/087; G06Q 10/083

(57) ABSTRACT

A method to be executed by an information processing apparatus includes assigning, to a delivery vehicle having a maximum loading capacity equal to or greater than a load amount of a first group of packages stored in a warehouse, a task to load collectively and deliver the first group of packages, and executing, upon a second group of packages entering the warehouse between assignment of the task and a predetermined time after assignment, a first modification process to modify the task so that the first group of packages and the second group of packages are loaded collectively and delivered, based on the load amount of the first group of packages, a load amount of the second group of packages, and the maximum loading capacity of the delivery vehicle.

### CROSS-REFERENCE TO RELATED APPLICATION

This application claims priority to Japanese Patent Application No. 2023-59352 filed on Mar. 31, 2023, the entire contents of which are incorporated herein by reference.

### TECHNICAL FIELD

The present disclosure relates to a method, an information processing apparatus, and a non-transitory computer readable medium.

### BACKGROUND

Conventional logistics systems for delivering packages stored in warehouses to consignees are known. For example, Patent Literature (PTL) 1 discloses that in a logistics system that assigns packages in a logistics warehouse to a transport vehicle, the logistics warehouse is instructed to make preparations according to a preparation plan, which is a plan for preparing packages to enter or leave the warehouse, and a transport vehicle is notified of delay information when a delay in the preparations from the preparation plan is detected.

### CITATION LIST

### Patent Literature

PTL 1: WO 2020/054490 A1

### SUMMARY

Conventional logistics systems generally employ a method of managing the entire delivery plan by assigning, to delivery vehicles, tasks to deliver packages stored in a warehouse. In such a method, the content of a task is not usually changed once the task has been assigned, since doing so could cause confusion among workers, for example. On the other hand, in a case in which a new package enters the warehouse after a task is assigned to a delivery vehicle, then even if the delivery vehicle's loading capacity has not been reached, the new package may, for example, end up being delivered by a different delivery vehicle. Such inconveniences might reduce the overall delivery efficiency.

It could be helpful to improve the delivery efficiency in logistics systems.

A method according to an embodiment of the present disclosure is a method to be executed by an information processing apparatus, the method including:
assigning, to a delivery vehicle having a maximum loading capacity equal to or greater than a load amount of a first group of packages stored in a warehouse, a task to load collectively and deliver the first group of packages; and
executing, upon a second group of packages entering the warehouse between assignment of the task and a predetermined time after assignment, a first modification process to modify the task so that the first group of packages and the second group of packages are loaded collectively and delivered, based on the load amount of the first group of packages, a load amount of the second group of packages, and the maximum loading capacity of the delivery vehicle.

An information processing apparatus according to an embodiment of the present disclosure includes a controller configured to:
assign, to a delivery vehicle having a maximum loading capacity equal to or greater than a load amount of a first group of packages stored in a warehouse, a task to load collectively and deliver the first group of packages; and
execute, upon a second group of packages entering the warehouse between assignment of the task and a predetermined time after assignment, a first modification process to modify the task so that the first group of packages and the second group of packages are loaded collectively and delivered, based on the load amount of the first group of packages, a load amount of the second group of packages, and the maximum loading capacity of the delivery vehicle.

A non-transitory computer readable medium according to an embodiment of the present disclosure stores a program configured to cause a computer to execute operations, the operations including:
assigning, to a delivery vehicle having a maximum loading capacity equal to or greater than a load amount of a first group of packages stored in a warehouse, a task to load collectively and deliver the first group of packages; and
executing, upon a second group of packages entering the warehouse between assignment of the task and a predetermined time after assignment, a first modification process to modify the task so that the first group of packages and the second group of packages are loaded collectively and delivered, based on the load amount of the first group of packages, a load amount of the second group of packages, and the maximum loading capacity of the delivery vehicle.

According to an embodiment of the present disclosure, the delivery efficiency in logistics systems is improved.

### BRIEF DESCRIPTION OF THE DRAWINGS

In the accompanying drawings:

FIG. 1 is a block diagram illustrating a schematic configuration of an information processing apparatus according to an embodiment of the present disclosure;

FIG. 2 is a flowchart illustrating a first example of operations of the information processing apparatus;

FIG. 3 is a diagram illustrating a first example of a first group of packages and a second group of packages;

FIG. 4 is a flowchart illustrating a second example of operations of the information processing apparatus;

FIG. 5 is a diagram illustrating a second example of the first group of packages and the second group of packages; and

FIG. 6 is a diagram illustrating a third example of the first group of packages and the second group of packages.

### DETAILED DESCRIPTION

Hereinafter, an embodiment of the present disclosure will be described.

### Outline of Embodiment

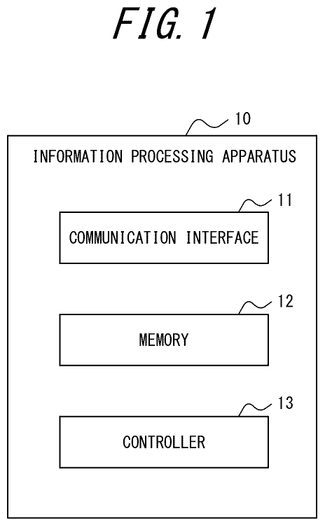

With reference to FIG. 1, an information processing apparatus 10 according to the embodiment of the present disclosure will be described. The information processing apparatus 10 is a computer, such as a personal computer (PC) or a server. In the present embodiment, the information processing apparatus 10 is used to provide a logistics service.

In a typical logistics service, packages to be delivered to a store or other consignee enter a warehouse. The packages that enter the warehouse are temporarily stored. When a certain amount of packages accumulates in the warehouse, delivery vehicles such as trucks are assigned the task of loading collectively and delivering the groups of packages that have accumulated in the warehouse. For example, the driver and other workers of the delivery vehicle collectively load groups of packages into the delivery vehicle at the warehouse and deliver each package to the corresponding consignee. Then, when package delivery is completed, the task ends. A typical logistics service thus involves task management related to package delivery.

First, an outline of the present embodiment will be described, and details thereof will be described later. The information processing apparatus assigns, to a delivery vehicle having a maximum loading capacity equal to or greater than a load amount of a first group of packages stored in a warehouse, a task to load collectively and deliver the first group of packages. Upon a second group of packages entering the warehouse between assignment of the task and a predetermined time after assignment, the information processing apparatus 10 executes a first modification process to modify the task so that the first group of packages and the second group of packages are loaded collectively and delivered, based on the load amount of the first group of packages, a load amount of the second group of packages, and the maximum loading capacity of the delivery vehicle.

Thus, according to the present embodiment, the task is allowed to be modified so that the first group of packages and the second group of packages are loaded collectively and delivered exclusively when the second group of packages newly enters the warehouse after the task to load collectively and deliver the first group of packages is assigned to the delivery vehicle up until a predetermined time after assignment. This reduces the possibility of an overall decrease in delivery efficiency, such as when a delivery vehicle's loading capacity has not been reached, yet a second group of packages still ends up being delivered by a different delivery vehicle. Also, the predetermined time can be set appropriately to reduce the risk of a situation that could cause confusion among workers, such as when a task is modified just before a delivery vehicle that has finished loading the first group of packages departs the warehouse. According to the present embodiment, the overall delivery efficiency can therefore be improved while reducing the possibility of confusion among workers.

### Configuration of Information Processing Apparatus

Next, configurations of the information processing apparatus 10 will be described in detail. As illustrated in FIG. 1, the information processing apparatus 10 includes a communication interface 11, a memory 12, and a controller 13.

The communication interface 11 includes at least one interface for communication for connecting to a network such as the Internet. The interface for communication is compliant with mobile communication standards such as the 4th generation (4G) standard and the 5th generation (5G) standard, a wired local area network (LAN) standard, or a wireless LAN standard, for example, but is not limited to these, and may be compliant with any communication standard. The communication interface 11 may further include an interface for communication that directly communicates with external devices. The interface for communication is, for example, compliant with a short-range wireless communication standard such as infrared or Bluetooth® (Bluetooth is a registered trademark in Japan, other countries, or both), but is not limited to these and may be compliant with any communication standard.

The memory 12 includes one or more memories. The memories are semiconductor memories, magnetic memories, optical memories, or the like, for example, but are not limited to these. The memories included in the memory 12 may each function as, for example, a main memory, an auxiliary memory, or a cache memory. The memory 12 stores any information used for operations of the information processing apparatus 10. For example, the memory 12 may store a system program, an application program, a database, and the like.

The controller 13 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 13 controls the operations of the entire information processing apparatus 10.

### Operations of Information Processing Apparatus

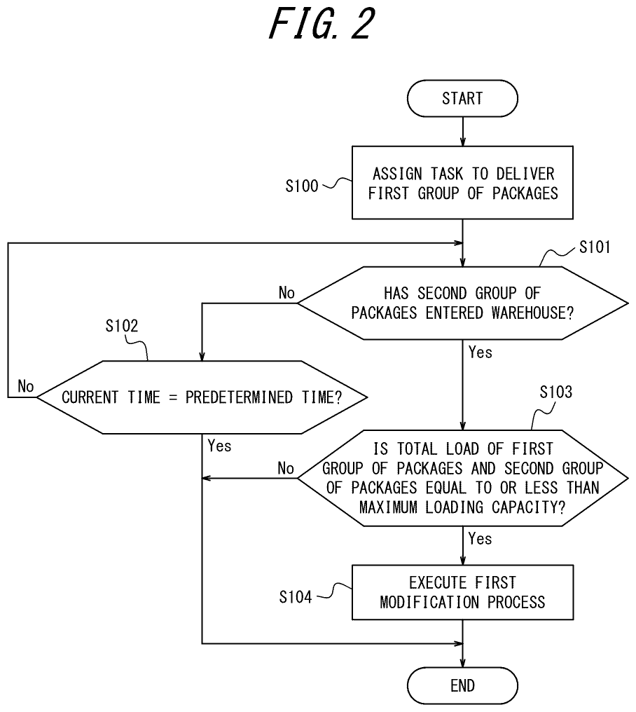

Next, operations of the information processing apparatus 10 will be described with reference to FIG. 2.

Step S100: the controller 13 of the information processing apparatus 10 assigns, to a delivery vehicle having a maximum loading capacity equal to or greater than a load amount of a first group of packages stored in a warehouse, a task to load collectively and deliver the first group of packages.

Specifically, the controller 13 assigns the task to the delivery vehicle by associating the task with the target vehicle and driver and storing the association in the memory 12. The “task” is, for example, information on the consignee who is the delivery destination of each package to be delivered (here, each package included in the first group of packages), information indicating the load amount of the first group of packages, the scheduled start time and scheduled completion time of the loading operation, the scheduled start time and scheduled completion time of the delivery operations, and the like. These examples are not limiting, however, and the task may include any information related to operations to be performed by the driver of the target vehicle. The controller 13 may also notify a terminal apparatus used by the driver of the target vehicle of the assigned task via the communication interface 11. The driver of the target vehicle may, for example, perform the task while confirming the notified information via the terminal apparatus.

In the present embodiment, the “load amount” is indicated by the number of packages, but this example is not limiting. The load amount may, for example, be indicated by weight or volume.

Step S101: the controller 13 determines whether a second group of packages has entered the warehouse. In a case in which it is determined that a second group of packages has entered the warehouse (step S101: Yes), the process advances to step S103. Conversely, in a case in which it is determined that a second group of packages has not entered the warehouse (step S101: No), the process advances to step S102.

Specifically, upon receiving information indicating that a warehousing operation for a second group of packages has been completed from the terminal apparatus of the worker in charge of the warehousing operation at the warehouse, for example, the controller 13 determines that the second group of packages has entered the warehouse. This information may include any information about the second group of packages, such as information on the consignee of each package included in the second group of packages, information indicating the load amount of the second group of packages, and the like.

Step S102: in a case in which it is determined in step S101 that the second group of packages has not entered the warehouse (step S101: No), the controller 13 determines whether the current time has reached a predetermined time. In a case in which it is determined that the current time has reached the predetermined time (step S102: Yes), the process ends. Conversely, in a case in which it is determined that the current time has not reached the predetermined time (S102: No), the process returns to step S101.

In other words, in steps S101 and S102 above, the controller 13 waits for the second group of packages to enter the warehouse until the current time reaches the predetermined time. The “predetermined time” in the present embodiment is the scheduled completion time of the loading operation of the first group of packages onto the delivery vehicle or the time at which the loading operation of the first group of packages is determined to be complete. Here, any method can be used to determine whether the loading operation of the first group of packages is complete. For example, the controller 13 may determine that the loading operation of the first group of packages is complete upon receiving information indicating that the loading operation of the first group of packages is complete from the terminal apparatus used by the driver of the delivery vehicle. The “predetermined time” is not limited to the above example and can be any time prior to the scheduled start time of the delivery operation for the task.

Step S103: in a case in which it is determined in step S101 that the second group of packages has entered the warehouse (step S101: Yes), the controller 13 determines whether the total load of the first group of packages and the second group of packages is equal to or less than the maximum loading capacity of the delivery vehicle. In a case in which the total load is determined to be equal to or less than the maximum loading capacity of the delivery vehicle (step S103: Yes), the process advances to step S104. Conversely, in a case in which the total load is determined to exceed the maximum loading capacity (step S103: No), the process ends.

Step S104: in a case in which it is determined in step S103 that the total load is equal to or less than the maximum loading capacity (step S103: Yes), the controller 13 executes the first modification process.

The “first modification process” is a process to modify the task assigned to the target vehicle in step S101 so that the first group of packages and the second group of packages are loaded collectively and delivered.

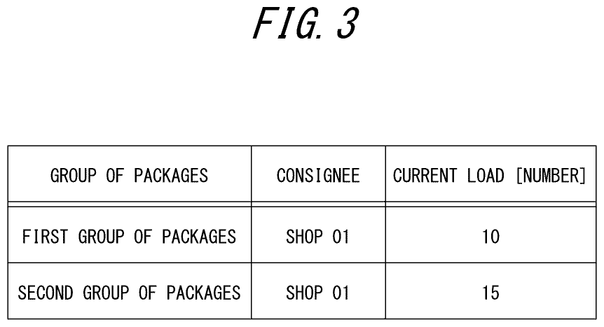

With reference to FIG. 3, the first modification process will be explained in detail. In the example illustrated in FIG. 3, the first group of packages includes 10 packages for which the consignee, i.e., the delivery destination, is “shop 01”. The second group of packages includes 15 packages for which the consignee, i.e., the delivery destination, is “shop 01”. As a result of execution of the first modification process, the task assigned to the target vehicle in step S101, i.e., the task “to load collectively and deliver the 10 packages included in the first group of packages to shop 01”, is modified to a task to “load collectively and deliver a total of 25 packages included in the first group of packages and the second group of packages to shop 01”.

As described above, the information processing apparatus 10 according to the present embodiment assigns, to a delivery vehicle having a maximum loading capacity equal to or greater than a load amount of a first group of packages stored in a warehouse, a task to load collectively and deliver the first group of packages. Upon a second group of packages entering the warehouse between assignment of the task and a predetermined time after assignment, the information processing apparatus 10 executes a first modification process to modify the task so that the first group of packages and the second group of packages are loaded collectively and delivered, based on the load amount of the first group of packages, a load amount of the second group of packages, and the maximum loading capacity of the delivery vehicle.

According to this configuration, the task is allowed to be modified so that the first group of packages and the second group of packages are loaded collectively and delivered exclusively when the second group of packages newly enters the warehouse after the task to load collectively and deliver the first group of packages is assigned to the delivery vehicle up until a predetermined time after assignment. This reduces the possibility of an overall decrease in delivery efficiency, such as when a delivery vehicle's loading capacity has not been reached, yet a second group of packages still ends up being delivered by a different delivery vehicle. Also, the predetermined time can be set appropriately to reduce the risk of a situation that could cause confusion among workers, such as when a task is modified just before a delivery vehicle that has finished loading the first group of packages departs the warehouse. According to the present embodiment, the overall delivery efficiency can therefore be improved while reducing the possibility of confusion among workers.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the information processing apparatus 10 in the above embodiment are distributed to multiple computers capable of communicating with each other can be implemented.

In the example described in the above embodiment, the process is terminated in a case in which it is determined in step S103 illustrated in FIG. 2 that the total load of the first groups of packages and the second group of packages exceeds the maximum loading capacity of the delivery vehicle (step S103: No). However, a variation such that the process continues even in a case in which the total load is determined to exceed the maximum loading capacity is also possible.

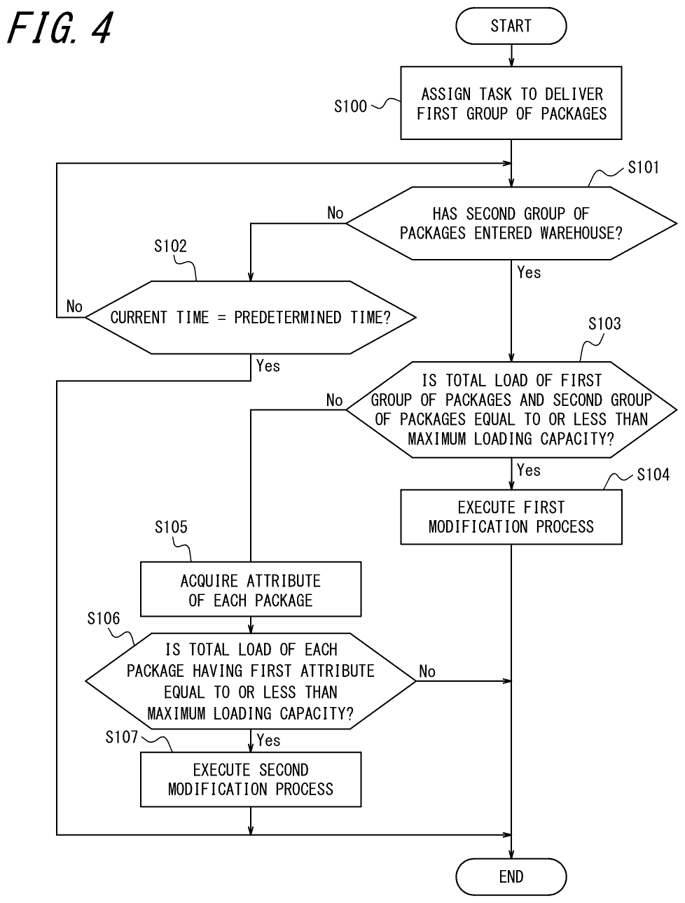

With reference to FIG. 4, this variation will be explained in detail. The operation of the information processing apparatus 10 illustrated in FIG. 4 differs from that illustrated in FIG. 2 in that steps S105 to S107 are added. Steps S105 to S107 are described below.

Step S105: in a case in which it is determined in step S103 that the total load exceeds the maximum loading capacity (step S103: No), the controller 13 acquires an attribute of each package in the first group of packages and the second group of packages.

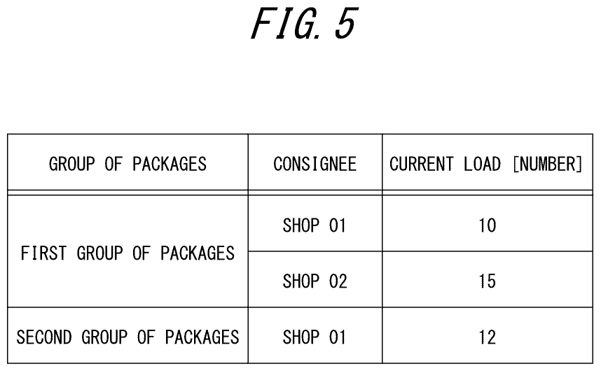

The “attribute” is any information about the package delivery operation. In the example described here, the attribute is information on the consignee, i.e., the delivery destination. In the example illustrated in FIG. 5, the first group of packages includes 10 packages whose consignee, i.e., delivery destination, is “shop 01”, and 15 packages whose consignee, i.e., delivery destination, is “shop 02”. The second group of packages includes 12 packages for which the consignee, i.e., the delivery destination, is “shop 01”. Here, the attribute indicating that the consignee, i.e., the delivery destination, is “shop 01” is referred to as the “first attribute”. The attribute indicating that the consignee, i.e., the delivery destination, is “shop 02” is referred to as the “second attribute”.

Step S106: the controller 13 determines whether the total load of each package having the first attribute in the first group of packages and the second group of packages is equal to or less than the maximum loading capacity of the delivery vehicle. In a case in which the total load is determined to be equal to or less than the maximum loading capacity of the delivery vehicle (step S106: Yes), the process advances to step S107. Conversely, in a case in which the total load is determined to exceed the maximum loading capacity (step S106: No), the process ends.

In the example illustrated in FIG. 5, the total load of each package having the first attribute in the first group of packages and the second group of packages (i.e., each package for which the consignee, i.e., the delivery destination, is “shop 01”) is 22 packages. It is therefore determined whether 22 packages is equal to or less than the maximum loading capacity.

Step S107: in a case in which it is determined in step S106 that the total load is equal to or less than the maximum loading capacity (step S106: Yes), the controller 13 executes the second modification process.

The “second modification process” is a process to modify the task assigned to the target vehicle in step S101 so that each package having the first attribute in the first group of packages and the second group of packages is loaded collectively and delivered.

In the example illustrated in FIG. 5, as a result of execution of the second modification process, the task assigned to the delivery vehicle in step S101, i.e., the task “to load collectively and deliver the 25 packages included in the first group of packages to shop 01 and shop 02”, is modified to a task to “load collectively and deliver 10 packages for shop 01 included in the first group of packages and 12 packages for shop 01 included in the second group of packages to shop 01”. By the task being modified by the second modification process, the target vehicle no longer needs to visit both shop 01 and shop 02 in a single delivery. The work time for delivery operations by the target vehicle can therefore be reduced, and overall delivery efficiency can be improved.

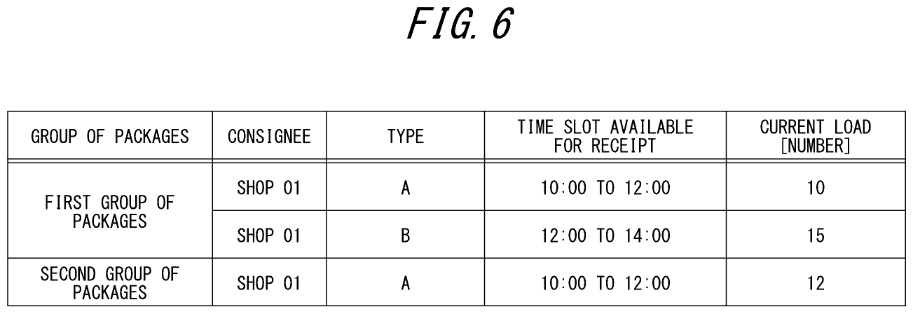

Although an example has been described in which the information on the consignee, i.e., the delivery destination, is an attribute, the attribute is not limited to this example. For example, the attribute may include information indicating a time slot available for receipt by the consignee, i.e., the delivery destination. The “time slot available for receipt” is the time slot during which the consignee allows receipt of the package. In addition, at shops in shopping malls or the like, the time slot available for receipt may differ depending on the product type of the package (such as “daily necessities”, “pharmaceuticals”, or “clothing”). In the example illustrated in FIG. 6, the first group of packages, for which the consignee, i.e., the delivery destination, is “shop 01”, includes 10 packages with a time slot available for receipt of “10:00 to 12:00” and 15 packages with a time slot available for receipt of “12:00 to 14:00”. The second group of packages, for which the consignee, i.e., the delivery destination, is “shop 01”, includes 12 packages with a time slot available for receipt of “10:00 to 12:00”. Here, the attribute indicating that the time slot available for receipt is “10:00 to 12:00” is referred to as the “first attribute”. The attribute indicating that the time slot available for receipt is “12:00 to 14:00” is referred to as the “second attribute”.

In such a case, the total load of each package having the first attribute in the first group of packages and the second group of packages (i.e., each package for which the time slot available for receipt is “10:00 to 12:00”) is 22 packages. It is therefore determined in the above-described step S106 whether 22 packages is equal to or less than the maximum loading capacity. In the above-described step S107, as a result of execution of the second modification process, the task assigned to the delivery vehicle in step S101, i.e., the task “to load collectively the 25 packages included in the first group of packages, deliver the 10 packages of type A to shop 01 between 10:00 and 12:00, and deliver the 15 packages of type B to shop 01 between 12:00 and 14:00”, is modified to a task to “load collectively the 10 packages of type A included in the first package group and the 12 packages of type A included in the second package group and deliver to shop 01 between 10:00 and 12:00”. By the task being modified by the second modification process, the target vehicle no longer needs to deliver the collectively loaded packages to shop 01 separately in different time slots. The work time for delivery operations by the target vehicle can therefore be reduced, and overall delivery efficiency can be improved.

For example, an embodiment in which a general purpose computer functions as the information processing apparatus 10 according to the above embodiment can also be implemented. Specifically, a program in which processes for realizing the functions of the information processing apparatus 10 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.
[Appendix 1] A method to be executed by an information processing apparatus, the method comprising:
   assigning, to a delivery vehicle having a maximum loading capacity equal to or greater than a load amount of a first group of packages stored in a warehouse, a task to load collectively and deliver the first group of packages; and
   executing, upon a second group of packages entering the warehouse between assignment of the task and a predetermined time after assignment, a first modification process to modify the task so that the first group of packages and the second group of packages are loaded collectively and delivered, based on the load amount of the first group of packages, a load amount of the second group of packages, and the maximum loading capacity of the delivery vehicle.
[Appendix 2] The method according to appendix 1, wherein the predetermined time is a scheduled completion time of a loading operation of the first group of packages onto the delivery vehicle or a time at which the loading operation of the first group of packages is determined to be complete.
[Appendix 3] The method according to appendix 1 or 2, wherein the information processing apparatus executes the first modification process in a case in which a total load amount of the first group of packages and the second group of packages is equal to or less than the maximum loading capacity of the delivery vehicle.
[Appendix 4] The method according to any one of appendices 1 to 3, further comprising:
   acquiring an attribute of each package included in the first group of packages and the second group of packages in a case in which a total load of the first group of packages and the second group of packages exceeds the maximum loading capacity of the delivery vehicle; and
   executing a second modification process to modify the task so that a plurality of packages selected from among the first group of packages and the second group of packages based on the acquired attributes is loaded collectively and delivered, a total load of the plurality of packages being equal to or less than the maximum loading capacity of the delivery vehicle.
[Appendix 5] The method according to any one of appendices 1 to 4, wherein
   the first group of packages includes a package having a first attribute and a package having a second attribute,
   the second group of packages includes a package having the first attribute, and
   in the second modification process, the information processing apparatus modifies the task so that among the first group of packages and the second group of packages, each package having the first attribute is loaded collectively and delivered in a case in which a total load of each package having the first attribute is equal to or less than the maximum loading capacity of the delivery vehicle.
[Appendix 6] The method according to any one of appendices 1 to 5, wherein
   the first attribute is information indicating that a delivery destination is a first consignee, and
   the second attribute is information indicating that the delivery destination is a second consignee.
[Appendix 7] The method according to any one of appendices 1 to 6, wherein
   the first attribute is information indicating that a time slot available for receipt by a consignee who is a delivery destination is a first time slot, and
   the second attribute is information indicating that a time slot available for receipt by the consignee who is the delivery destination is a second time slot.
[Appendix 8] An information processing apparatus comprising a controller configured to:
   assign, to a delivery vehicle having a maximum loading capacity equal to or greater than a load amount of a first group of packages stored in a warehouse, a task to load collectively and deliver the first group of packages; and
   execute, upon a second group of packages entering the warehouse between assignment of the task and a predetermined time after assignment, a first modification process to modify the task so that the first group of packages and the second group of packages are loaded collectively and delivered, based on the load amount of the first group of packages, a load amount of the second group of packages, and the maximum loading capacity of the delivery vehicle.
[Appendix 9] The information processing apparatus according to appendix 8, wherein the predetermined time is a scheduled completion time of a loading operation of the first group of packages onto the delivery vehicle or a time at which the loading operation of the first group of packages is determined to be complete.
[Appendix 10] The information processing apparatus according to appendix 8 or 9, wherein the controller is configured to execute the first modification process in a case in which a total load amount of the first group of packages and the second group of packages is equal to or less than the maximum loading capacity of the delivery vehicle.
[Appendix 11] The information processing apparatus according to any one of appendices 8 to 10, wherein the controller is configured to
   acquire an attribute of each package included in the first group of packages and the second group of packages in a case in which a total load of the first group of packages and the second group of packages exceeds the maximum loading capacity of the delivery vehicle, and
   execute a second modification process to modify the task so that a plurality of packages selected from among the first group of packages and the second group of packages based on the acquired attributes is loaded collectively and delivered, a total load of the plurality of packages being equal to or less than the maximum loading capacity of the delivery vehicle.
[Appendix 12] The information processing apparatus according to any one of appendices 8 to 11, wherein
   the first group of packages includes a package having a first attribute and a package having a second attribute,
   the second group of packages includes a package having the first attribute, and
   in the second modification process, the controller is configured to modify the task so that among the first group of packages and the second group of packages, each package having the first attribute is loaded collectively and delivered in a case in which a total load of each package having the first attribute is equal to or less than the maximum loading capacity of the delivery vehicle.
[Appendix 13] The information processing apparatus according to any one of appendices 8 to 12, wherein
   the first attribute is information indicating that a delivery destination is a first consignee, and
   the second attribute is information indicating that the delivery destination is a second consignee.
[Appendix 14] The information processing apparatus according to any one of appendices 8 to 13, wherein
   the first attribute is information indicating that a time slot available for receipt by a consignee who is a delivery destination is a first time slot, and
   the second attribute is information indicating that a time slot available for receipt by the consignee who is the delivery destination is a second time slot.
[Appendix 15] A program configured to cause an information processing apparatus to execute operations, the operations comprising:
   assigning, to a delivery vehicle having a maximum loading capacity equal to or greater than a load amount of a first group of packages stored in a warehouse, a task to load collectively and deliver the first group of packages; and
   executing, upon a second group of packages entering the warehouse between assignment of the task and a predetermined time after assignment, a first modification process to modify the task so that the first group of packages and the second group of packages are loaded collectively and delivered, based on the load amount of the first group of packages, a load amount of the second group of packages, and the maximum loading capacity of the delivery vehicle.
[Appendix 16] The program according to appendix 15, wherein the information processing apparatus executes the first modification process in a case in which a total load amount of the first group of packages and the second group of packages is equal to or less than the maximum loading capacity of the delivery vehicle.
[Appendix 17] The program according to appendix 15 or 16, wherein the operations further comprise:
   acquiring an attribute of each package included in the first group of packages and the second group of packages in a case in which a total load of the first group of packages and the second group of packages exceeds the maximum loading capacity of the delivery vehicle; and
   executing a second modification process to modify the task so that a plurality of packages selected from among the first group of packages and the second group of packages based on the acquired attributes is loaded collectively and delivered, a total load of the plurality of packages being equal to or less than the maximum loading capacity of the delivery vehicle.
[Appendix 18] The program according to any one of appendices 15 to 17, wherein
   the first group of packages includes a package having a first attribute and a package having a second attribute,
   the second group of packages includes a package having the first attribute, and
   in the second modification process, the information processing apparatus modifies the task so that among the first group of packages and the second group of packages, each package having the first attribute is loaded collectively and delivered in a case in which a total load of each package having the first attribute is equal to or less than the maximum loading capacity of the delivery vehicle.
[Appendix 19] The program according to any one of appendices 15 to 18, wherein
   the first attribute is information indicating that a delivery destination is a first consignee, and
   the second attribute is information indicating that the delivery destination is a second consignee.
[Appendix 20] The program according to any one of appendices 15 to 19, wherein
   the first attribute is information indicating that a time slot available for receipt by a consignee who is a delivery destination is a first time slot, and
   the second attribute is information indicating that a time slot available for receipt by the consignee who is the delivery destination is a second time slot.

1. A method to be executed by an information processing apparatus, the method comprising:
assigning, to a delivery vehicle having a maximum loading capacity equal to or greater than a load amount of a first group of packages stored in a warehouse, a task to load collectively and deliver the first group of packages; and
executing, upon a second group of packages entering the warehouse between assignment of the task and a predetermined time after assignment, a first modification process to modify the task so that the first group of packages and the second group of packages are loaded collectively and delivered, based on the load amount of the first group of packages, a load amount of the second group of packages, and the maximum loading capacity of the delivery vehicle.

2. The method according to claim 1, wherein the predetermined time is a scheduled completion time of a loading operation of the first group of packages onto the delivery vehicle or a time at which the loading operation of the first group of packages is determined to be complete.

3. The method according to claim 1, wherein the information processing apparatus executes the first modification process in a case in which a total load amount of the first group of packages and the second group of packages is equal to or less than the maximum loading capacity of the delivery vehicle.

4. The method according to claim 1, further comprising:
acquiring an attribute of each package included in the first group of packages and the second group of packages in a case in which a total load of the first group of packages and the second group of packages exceeds the maximum loading capacity of the delivery vehicle; and
executing a second modification process to modify the task so that a plurality of packages selected from among the first group of packages and the second group of packages based on the acquired attributes is loaded collectively and delivered, a total load of the plurality of packages being equal to or less than the maximum loading capacity of the delivery vehicle.

5. The method according to claim 4, wherein
the first group of packages includes a package having a first attribute and a package having a second attribute,
the second group of packages includes a package having the first attribute, and
in the second modification process, the information processing apparatus modifies the task so that among the first group of packages and the second group of packages, each package having the first attribute is loaded collectively and delivered in a case in which a total load of each package having the first attribute is equal to or less than the maximum loading capacity of the delivery vehicle.

6. The method according to claim 5, wherein
the first attribute is information indicating that a delivery destination is a first consignee, and
the second attribute is information indicating that the delivery destination is a second consignee.

7. The method according to claim 5, wherein
the first attribute is information indicating that a time slot available for receipt by a consignee who is a delivery destination is a first time slot, and
the second attribute is information indicating that a time slot available for receipt by the consignee who is the delivery destination is a second time slot.

8. An information processing apparatus comprising a controller configured to:
assign, to a delivery vehicle having a maximum loading capacity equal to or greater than a load amount of a first group of packages stored in a warehouse, a task to load collectively and deliver the first group of packages; and
execute, upon a second group of packages entering the warehouse between assignment of the task and a predetermined time after assignment, a first modification process to modify the task so that the first group of packages and the second group of packages are loaded collectively and delivered, based on the load amount of the first group of packages, a load amount of the second group of packages, and the maximum loading capacity of the delivery vehicle.

9. The information processing apparatus according to claim 8, wherein the predetermined time is a scheduled completion time of a loading operation of the first group of packages onto the delivery vehicle or a time at which the loading operation of the first group of packages is determined to be complete.

10. The information processing apparatus according to claim 8, wherein the controller is configured to execute the first modification process in a case in which a total load amount of the first group of packages and the second group of packages is equal to or less than the maximum loading capacity of the delivery vehicle.

11. The information processing apparatus according to claim 8, wherein the controller is configured to
acquire an attribute of each package included in the first group of packages and the second group of packages in a case in which a total load of the first group of packages and the second group of packages exceeds the maximum loading capacity of the delivery vehicle, and
execute a second modification process to modify the task so that a plurality of packages selected from among the first group of packages and the second group of packages based on the acquired attributes is loaded collectively and delivered, a total load of the plurality of packages being equal to or less than the maximum loading capacity of the delivery vehicle.

12. The information processing apparatus according to claim 11, wherein
the first group of packages includes a package having a first attribute and a package having a second attribute,
the second group of packages includes a package having the first attribute, and
in the second modification process, the controller is configured to modify the task so that among the first group of packages and the second group of packages, each package having the first attribute is loaded collectively and delivered in a case in which a total load of each package having the first attribute is equal to or less than the maximum loading capacity of the delivery vehicle.

13. The information processing apparatus according to claim 12, wherein
the first attribute is information indicating that a delivery destination is a first consignee, and
the second attribute is information indicating that the delivery destination is a second consignee.

14. The information processing apparatus according to claim 12, wherein
the first attribute is information indicating that a time slot available for receipt by a consignee who is a delivery destination is a first time slot, and
the second attribute is information indicating that a time slot available for receipt by the consignee who is the delivery destination is a second time slot.

15. A non-transitory computer readable medium storing a program configured to cause a computer to execute operations, the operations comprising:
assigning, to a delivery vehicle having a maximum loading capacity equal to or greater than a load amount of a first group of packages stored in a warehouse, a task to load collectively and deliver the first group of packages; and
executing, upon a second group of packages entering the warehouse between assignment of the task and a predetermined time after assignment, a first modification process to modify the task so that the first group of packages and the second group of packages are loaded collectively and delivered, based on the load amount of the first group of packages, a load amount of the second group of packages, and the maximum loading capacity of the delivery vehicle.

16. The medium according to claim 15, wherein the computer executes the first modification process in a case in which a total load amount of the first group of packages and the second group of packages is equal to or less than the maximum loading capacity of the delivery vehicle.

17. The medium according to claim 15, wherein the operations further comprise:
acquiring an attribute of each package included in the first group of packages and the second group of packages in a case in which a total load of the first group of packages and the second group of packages exceeds the maximum loading capacity of the delivery vehicle; and
executing a second modification process to modify the task so that a plurality of packages selected from among the first group of packages and the second group of packages based on the acquired attributes is loaded collectively and delivered, a total load of the plurality of packages being equal to or less than the maximum loading capacity of the delivery vehicle.

18. The medium according to claim 17, wherein
the first group of packages includes a package having a first attribute and a package having a second attribute,
the second group of packages includes a package having the first attribute, and
in the second modification process, the computer modifies the task so that among the first group of packages and the second group of packages, each package having the first attribute is loaded collectively and delivered in a case in which a total load of each package having the first attribute is equal to or less than the maximum loading capacity of the delivery vehicle.

19. The medium according to claim 18, wherein
the first attribute is information indicating that a delivery destination is a first consignee, and
the second attribute is information indicating that the delivery destination is a second consignee.

20. The medium according to claim 18, wherein
the first attribute is information indicating that a time slot available for receipt by a consignee who is a delivery destination is a first time slot, and
the second attribute is information indicating that a time slot available for receipt by the consignee who is the delivery destination is a second time slot.
